(19) United States
(12) Patent Application Publication
(10) Pub. No.: US 2016/0083178 A1
(43) Pub. Date: Mar. 24, 2016

(54) GARBAGE CAN CADDY

(71) Applicants: CHARLOTTE GOFF, CHINO, CA (US); DONALD GOFF, CHINO, CA (US)

(72) Inventors: CHARLOTTE GOFF, CHINO, CA (US); DONALD GOFF, CHINO, CA (US)

(21) Appl. No.: 14/843,809

(22) Filed: Sep. 2, 2015

Related U.S. Application Data
(60) Provisional application No. 62/044,912, filed on Sep. 2, 2014.

(51) Int. Cl. B65D 90/00; B65F 1/06

(52) U.S. Cl. CPC B65D 90/0053; B65F 1/062

(57) ABSTRACT

A receptacle device to house trash can liners on the inside or outside of a garbage can comprising an S-shape that fits over the upper edge of a garbage can and supports a box of garbage can liners.

### CLAIM OF PRIORITY

This patent application claims priority under 35 USC 119 (e) (1) from U.S. Provisional Patent Application Ser. No. 62/044,912 filed Sep. 2, 2014, of common inventorship herewith entitled, “Garbage Can Caddy,” which is incorporated herein by reference as though the same were set forth in its entirety.

### FIELD OF THE INVENTION

The present invention pertains to the field of waste receptacles, and more specifically to the field of waste bag holders.

### BACKGROUND OF THE INVENTION

The prior art has put forth several designs for waste bag holders. Among these are:

U.S. Pat. No. 8,292,114 to William T. Tabele, Jr. describes a device for securing a garbage bag in a garbage receptacle. This invention comprises an elongated U shaped base bar having a front panel and a back panel connected by means of a connector segment. The base bar is adapted to wrap snugly over a top edge of the garbage receptacle and simultaneously sandwich the garbage bag. An anchor component contains a first attachment means for securing the anchor component to the garbage receptacle and a cord for connecting the anchor component and the base bar.

US Patent 2008/0191103 to Lorne Thurgar describes a resiliently deformable clip for holding a liner in a garbage bin. The aforementioned clip has an inner leg and an outer leg that clips over a lip of the bin. A ridge formed on the surface of the outer leg catches under the lip to hold the clip in place. A grip on the outer leg allows the clip to be removed without reaching into the bin.

US Patent 2008/0173648 to Juan C. Escobar, Paul Silberschatz, Kristine Chan-Lizardo, Stephen Wahl, Emily Ma, Jan Raken and David Thomsen describes a trash receptacle having a bag retaining system that includes a housing having a body and a cover configured to removably engage the body, a liner having an upper rim and configured to reside within the housing, and a plurality of clips. Each clip has a resilient arm portion with each clip secured to the cover such that the resilient arm portion of each clip biases against the upper rim of the liner, thereby retaining a disposable bag in place within the liner when the cover engages the body. The plurality of clips is removable to allow replacement of clips or adaptation to different system configurations. Alternatively, the clips are permanently affixable to the cover of the housing. The resilient arm portion of each clip preferably biases against either an outer surface of the liner upper rim or against an inner surface of the liner upper rim.

None of these prior art references describe the present invention.

### SUMMARY OF THE INVENTION

It is an object of the present invention to provide a receptacle that is innovatively constructed to house trash can liners on the inside or outside of the garbage can.

### BRIEF DESCRIPTION OF THE DRAWINGS

FIG. 1 is a prototypical diagonal close up view showing the present invention fabricated in a heavy duty, dark colored plastic.

FIG. 2 is a prototypical functional diagonal view showing the present invention inserted on the interior of a rectangularly shaped trash receptacle.

FIG. 3 is a prototypical functional diagonal view showing the present invention inserted on the exterior of a circularly shaped trash receptacle.

FIG. 4 is an illustrative functional diagonal view of the present invention holding a trash bag container and inserted on the exterior of a rectangularly shaped trash receptacle.

FIG. 5 is a prototypical functional diagonal close up view showing the present invention inserted on a side lip of a rectangular shaped trash receptacle.

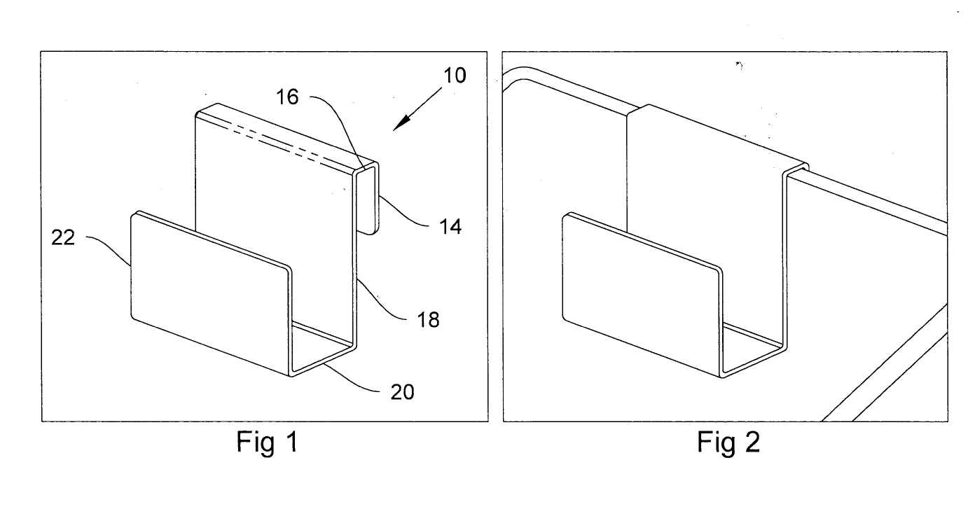

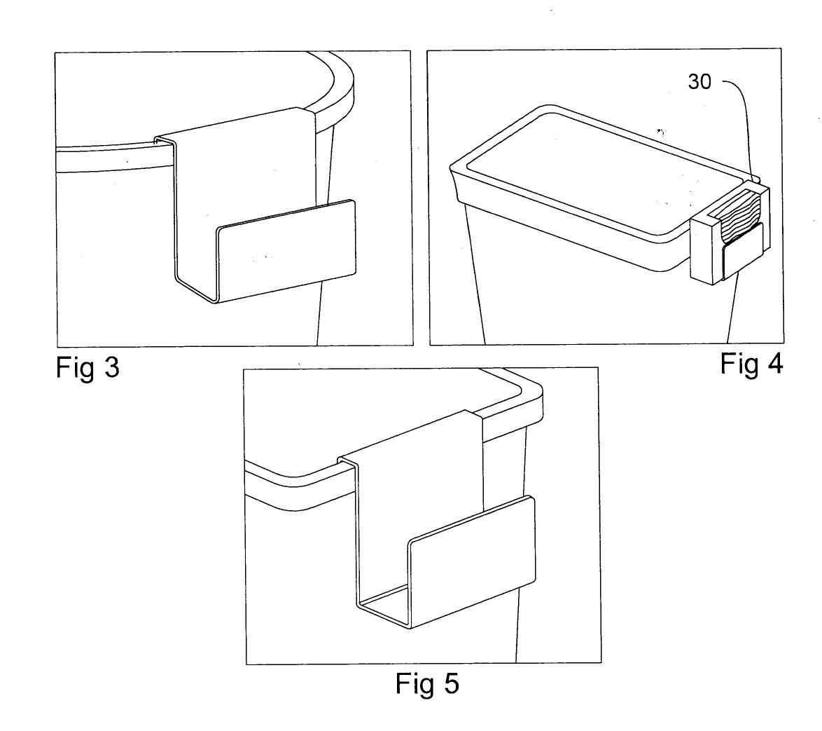

### DETAILED DESCRIPTION OF THE INVENTION

For most people, a daily disposal of garbage is a necessary fact of life. Empty milk jugs, food containers, clothing tags, used razor blades, orange peels, scraps of paper and soda pop bottles are just a few items tossed in one's trash receptacles. An average consumer discards approximately four and four tenths pounds of trash daily with approximately forty percent of this garbage being produced in the kitchen. Produced in a variety of sizes, garbage cans generally are found in kitchens, bathrooms, bedrooms, laundry rooms and garages to provide consumers a convenient means of collecting waste. Most consumers find that lining their garbage cans with disposable plastic trash bags reduces the mess associated with the collection of waste. Trash bags are particularly useful because they keep the interior of the garbage can clean and free of debris. This functionality is especially important in the kitchen where leaky cartons of milk, egg shells and bits of food quickly grow moldy and emit a foul odor when left to collect in the bottom of a trash can.

Although trash bags are a necessary and practical item, they pose a storage challenge. Packaged in oversized cardboard boxes, a container of large outdoor garbage bags or even a roll of small kitchen bags takes up a great deal of valuable storage space within a utility closet or underneath the sink. For countless consumers who fill their cabinets and closets to the brim with cleaning supplies, groceries and other items, finding room for and accessing their stored garbage bags for use when needed is difficult. When a full bag is removed from the trash can, easily accessing a replacement bag can prove frustrating. Rather than run all over the house, wasting time trying to find where bags are stored, some individuals simply leave the can bare for the next person to replace the liner.

The present invention, hereinafter referred to as the Garbage Can Caddy, is a receptacle that is specially constructed to house trash can liners on the inside or outside of the garbage can. The Garbage Can Caddy provides users with an easily accessible and convenient storage space for garbage bags. The present invention also ensures that emptied waste cans are relined immediately with clean replacement bags.

Please refer to the Figures. The present invention is a plastic receptacle 10 that fits over the upper edge of a garbage can comprising a device having a squared off S-configuration. Lip 14 serves to brace the device against the side of garbage can, wherein the lip 14 terminates at an approximately ninety degree angle in an upper rim 16. Upper rim 16 rests on the top edge of the garbage can and terminates in an approximately ninety degree angle in back 18. Back 18 rests along the side of the garbage can and terminates in an approximately ninety degree angle in bottom 20. Bottom 20, in combination with back 18 support a box of garbage can liners 30. Bottom 20 terminates at an approximately ninety degree angle in front lip 22. The box of garbage can liners 30 is further secured by front lip 22.

Fabricated of durable plastic or metal materials, a standard Garbage Can Caddy is rectangular in shape. The Garbage Can Caddy measures approximately four and one quarter inches in height, five inches in width, and three and three eighths inches in depth. The aforementioned measurements constitute a medium sized Garbage Can Caddy which is ideal for use with kitchen trash cans. The Garbage. Can Caddy is available in a larger size for outdoor and industrial garbage cans, and a smaller size for bathroom trash cans. Germane to all sizes is the Garbage Can Caddy's S type configuration that fits snugly over a trash can or waste basket's rim. The present invention's open slot is sized appropriately to hold a smaller box of plastic bin liners or a set of folded plastic bin liners without the aforementioned box. The open slot is formed by back 18, bottom 20 and front lip 22. The Garbage Can Caddy is produced in a wide array of appealing colors as well as standard black or white.

Use and application of the Garbage Can Caddy is simple and straightforward. A user selects the present invention based on the size of waste receptacle to which it attaches and the user's personal preference of color. A vibrantly colored, medium sized Garbage Can Caddy is appropriate in a kitchen to accentuate that room's decorative motif. A white or black colored, large sized Garbage Can Caddy is serviceable and striking in a garage. The Garbage Can Caddy's storage section may rest on an exterior surface or interior surface of the garbage receptacle, depending on whether the user wants the bags visible or out of view. After placing a clean liner in a waste can, the user attaches a Garbage Can Caddy to the rim of the waste can. A boxed container of liners or a set of folded liners are insertable into the present invention with bags in full view and readily accessible when it is time to replace full bags.

The Garbage Can Caddy provides individuals with an easy means of storing, accessing, and using garbage bags. The Garbage Can Caddy is a space saver and a practical alternative to storing garbage bags in overcrowded cupboards, cabinets and closets. Easily accessed, the present invention enables users to quickly and conveniently replace used bags with a fresh, clean garbage bag in a manner of seconds. The Garbage Can Caddy is highly efficient and functional for home use, professional cleaning services, businesses, restaurants and office establishments. Durably constructed, the present invention will withstand years of repeated use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A receptacle device to house garbage can liners on the inside or outside of a garbage can, comprising: a squared off S-shaped device that fits over the upper edge of a garbage can having a lip capable of bracing the device against the side of garbage can, wherein the lip terminates at an approximately ninety degree angle in an upper rim, wherein the upper rim is capable of resting on the top edge of the garbage can, wherein the upper rim terminates at an approximately ninety degree angle in a back, wherein the back is capable of resting along the side of the garbage can, wherein the back terminates at an approximately ninety degree angle in a bottom, wherein the bottom and back are capable of supporting a box of garbage can liners, wherein the bottom terminates at an approximately ninety degree angle in front lip, wherein front lip is capable of securing the box of garbage can liners.

2. The receptacle device of claim 1, fabricated of durable plastic or metal materials.

3. The receptacle device of claim 1, wherein the device measures approximately four and one quarter inches in height, five inches in width, and three and three eighths inches in depth.

4. The receptacle device of claim 1, produced in a color or black or white.

5. The receptacle device of claim 1 sized to accommodate large garbage cans for outside use or industrial use.

6. The receptacle device of claim 1 sized to accommodate small garbage cans for bathroom or bedroom use.
